(19) United States
(12) Patent Application Publication
(10) Pub. No.: US 2024/0380503 A1
(43) Pub. Date: Nov. 14, 2024

(54) NON-CONTIGUOUS RESOURCES FOR CROSS-LINK INTERFERENCE AND CHANNEL STATE INFORMATION REPORTS

(71) Applicant: QUALCOMM Incorporated, San Diego, CA (US)

(72) Inventors: Abdelrahman Mohamed Ahmed Mohamed IBRAHIM, San Diego, CA (US); Muhammad Sayed Khairy ABDELGHAFFAR, San Jose, CA (US); Qian ZHANG, Basking Ridge, NJ (US)

(21) Appl. No.: 18/650,929

(22) Filed: Apr. 30, 2024

Related U.S. Application Data
(60) Provisional application No. 63/501,931, filed on May 12, 2023.

(51) Int. Cl. H04B 17/309; H04B 7/06; H04L 1/1607; H04L 5/14

(52) U.S. Cl. CPC H04B 17/346; H04B 7/0626; H04L 1/1614; H04L 5/14

(57) ABSTRACT

Various aspects of the present disclosure generally relate to wireless communication. In some aspects, a user equipment (UE) may receive a configuration for a resource associated with cross-link interference (CLI). The resource is associated with subband full duplex and is non-contiguous in frequency. The UE may receive a configuration for a report associated with the resource. The UE may perform a measurement using the resource associated with CLI. The UE may transmit a report associated with the measurement. Numerous other aspects are described.

### CROSS-REFERENCE TO RELATED APPLICATION

This Patent application claims priority to U.S. Provisional Application No. 63/501,931, filed on May 12, 2023, entitled “NON-CONTIGUOUS RESOURCES FOR CROSS-LINK INTERFERENCE AND CHANNEL STATE INFORMATION REPORTS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for configuring and using non-contiguous resources for cross-link interference and channel state information reports.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a configuration for a resource associated with cross-link interference (CLI), wherein the resource is associated with subband full duplex (SBFD) and is non-contiguous in frequency. The method may include receiving a configuration for a report associated with the resource. The method may include performing a measurement using the resource associated with CLI. The method may include transmitting a report associated with the measurement.

Some aspects described herein relate to a method of wireless communication performed by a network node. The method may include transmitting a configuration for a resource associated with CLI, wherein the resource is associated with SBFD and is non-contiguous in frequency. The method may include transmitting a configuration for a report associated with the resource. The method may include receiving a report associated with a measurement on the resource associated with CLI.

Some aspects described herein relate to a non-transitory computer-readable medium that stores a set of instructions for wireless communication by a UE. The set of instructions, when executed by one or more processors of the UE, may cause the UE to receive a configuration for a resource associated with CLI, wherein the resource is associated with SBFD and is non-contiguous in frequency. The set of instructions, when executed by one or more processors of the UE, may cause the UE to receive a configuration for a report associated with the resource. The set of instructions, when executed by one or more processors of the UE, may cause the UE to perform a measurement using the resource associated with CLI. The set of instructions, when executed by one or more processors of the UE, may cause the UE to transmit a report associated with the measurement.

Some aspects described herein relate to a non-transitory computer-readable medium that stores a set of instructions for wireless communication by a network node. The set of instructions, when executed by one or more processors of the network node, may cause the network node to transmit a configuration for a resource associated with CLI, wherein the resource is associated with SBFD and is non-contiguous in frequency. The set of instructions, when executed by one or more processors of the network node, may cause the network node to transmit a configuration for a report associated with the resource. The set of instructions, when executed by one or more processors of the network node, may cause the network node to receive a report associated with a measurement on the resource associated with CLI.

Some aspects described herein relate to an apparatus for wireless communication at a UE. The apparatus may include one or more memories and one or more processors coupled to the one or more memories. The one or more processors may be configured to receive a configuration for a resource associated with CLI, wherein the resource is associated with SBFD and is non-contiguous in frequency. The one or more processors may be configured to receive a configuration for a report associated with the resource. The one or more processors may be configured to perform a measurement using the resource associated with CLI. The one or more processors may be configured to transmit a report associated with the measurement.

Some aspects described herein relate to an apparatus for wireless communication at a network node. The apparatus may include one or more memories and one or more processors coupled to the one or more memories. The one or more processors may be configured to transmit a configuration for a resource associated with CLI, wherein the resource is associated with SBFD and is non-contiguous in frequency. The one or more processors may be configured to transmit a configuration for a report associated with the resource. The one or more processors may be configured to receive a report associated with a measurement on the resource associated with CLI.

Some aspects described herein relate to an apparatus for wireless communication. The apparatus may include means for receiving a configuration for a resource associated with CLI, wherein the resource is associated with SBFD and is non-contiguous in frequency. The apparatus may include means for receiving a configuration for a report associated with the resource. The apparatus may include means for performing a measurement using the resource associated with CLI. The apparatus may include means for transmitting a report associated with the measurement.

Some aspects described herein relate to an apparatus for wireless communication. The apparatus may include means for transmitting a configuration for a resource associated with CLI, wherein the resource is associated with SBFD and is non-contiguous in frequency. The apparatus may include means for transmitting a configuration for a report associated with the resource. The apparatus may include means for receiving a report associated with a measurement on the resource associated with CLI.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment in a wireless network, in accordance with the present disclosure.

FIG. 3 is a diagram illustrating an example disaggregated base station architecture, in accordance with the present disclosure.

FIG. 4 is a diagram illustrating an example of subband full duplex, in accordance with the present disclosure.

FIGS. 5A, 5B, and 5C are diagrams illustrating examples of full duplex communication in accordance with the present disclosure.

FIGS. 6 and 7 are diagrams illustrating examples associated with configuring and using non-contiguous resources for cross-link interference (CLI) and channel state information (CSI) reports, in accordance with the present disclosure.

FIGS. 8 and 9 are diagrams illustrating example processes associated with configuring and using non-contiguous resources for CLI and CSI reports, in accordance with the present disclosure.

FIGS. 10 and 11 are diagrams of example apparatuses for wireless communication, in accordance with the present disclosure.

### DETAILED DESCRIPTION

A user equipment (UE) may simultaneously receive and transmit using subband full duplex (SBFD). In SBFD, a bandwidth (BW) including a set of resource blocks (RBs) is divided such that some RBs are associated with downlink and other RBs are associated with uplink. As used herein, “resource block” or “RB” may refer to one or more subcarriers (e.g., each subcarrier may include one or more frequencies), which may be consecutive in a frequency domain. Accordingly, an RB may include a plurality of resource elements (REs), where each RE corresponds to a single subcarrier. “Subcarrier” may refer to a frequency based at least in part on a “carrier” frequency. Dividing the RBs into uplink and downlink increases throughput to UEs and can decrease latency (e.g., by providing earlier uplink and/or downlink opportunities, as compared with non-SBFD configurations). However, SBFD configurations may result in cross-link interference (CLI) between nearby UEs caused, at least in part, by leakage from uplink RBs into downlink RBs. Attempting to estimate CLI by measuring the whole BW is not particularly accurate and thus can reduce quality and reliability of communications with the UEs because mitigations based on less accurate CLI are less effective. Reduced quality and reliability results in wasted power and processing resources at the UEs due to longer decoding cycles and even retransmissions. Additionally, attempting to estimate channel quality (e.g., using channel state information (CSI) reference signals (CSI-RSs)) by measuring the whole BW is similarly inaccurate. Inaccurate CSI reporting can reduce quality and reliability of communications with the UEs when channel conditions are bad (e.g., because mitigations such as higher modulation and coding schemes (MCSs) are not used). Alternatively, inaccurate CSI reporting can waste power and processing resources at the UEs when channel conditions are good (e.g., because unnecessarily high MCSs are used).

Various aspects relate generally to wireless communication and more particularly to configuring measurement resources, associated with SBFD, that are non-contiguous in frequency. As used herein, “non-contiguous in frequency” refers to a set of frequencies that excludes one or more frequencies that are between members of the set rather than on a boundary of the set. Some aspects more specifically relate to explicitly indicating one or more uplink RBs to be excluded from the measurement resource. For example, a network may use multiple starting indices and quantities, multiple starting indices and ending indices, or a bitmap to indicate the one or more uplink RBs to be excluded. Alternatively, a UE may determine the one or more uplink RBs to be excluded from the measurement resource. For example, the UE may determine the one or more uplink RBs to be excluded based at least in part on an SBFD configuration. Some aspects more specifically relate to explicitly linking two portions of the measurement resource. For example, a network may link the portions using a new data structure or a resource set. Alternatively, the two portions may be linked implicitly. For example, the network may link the portions within a report configuration.

Particular aspects of the subject matter described in this disclosure can be implemented to realize one or more of the following potential advantages. In some examples, because the measurement resource excludes one or more uplink RBs, the described techniques can be used to generate a more accurate CLI report or CSI report. As a result, the network and the UE may more effectively mitigate CLI and/or tune channel parameters to increase quality and reliability of communications. In some aspects, the network may explicitly indicate the one or more uplink RBs to exclude in order to conserve power and processing resources at the UE. Alternatively, the UE may determine the one or more uplink RBs to exclude in order to reduce network overhead.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

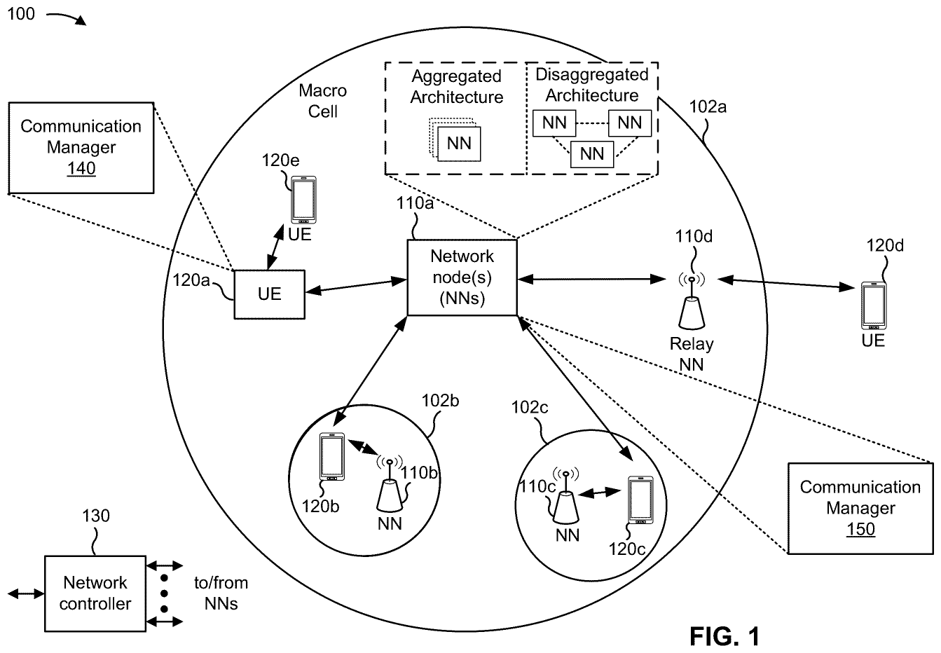

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (cMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FRI (410 MHz-7.125 GHZ) and FR2 (24.25 GHZ-52.6 GHZ). It should be understood that although a portion of FR1 is greater than 6 GHZ, FRI is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHZ) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHz), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FRI, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FRI, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a configuration for a resource, associated with CLI or CSI, that is associated with SBFD and is non-contiguous in frequency; may receive a configuration for a report associated with the resource; may perform a measurement using the resource associated with CLI or CSI; and may transmit a report associated with the measurement. Additionally, or alternatively, the communication manager 140 may perform one or more other operations described herein.

In some aspects, the network node 110 may include a communication manager 150. As described in more detail elsewhere herein, the communication manager 150 may transmit a configuration for a resource, associated with CLI or CSI, that is associated with SBFD and is non-contiguous in frequency; may transmit a configuration for a report associated with the resource; and may receive a report associated with a measurement on the resource associated with CLI or CSI. Additionally, or alternatively, the communication manager 150 may perform one or more other operations described herein.

As indicated above, FIG. 1 is provided as an example. Other examples may differ from what is described with regard to FIG. 1.

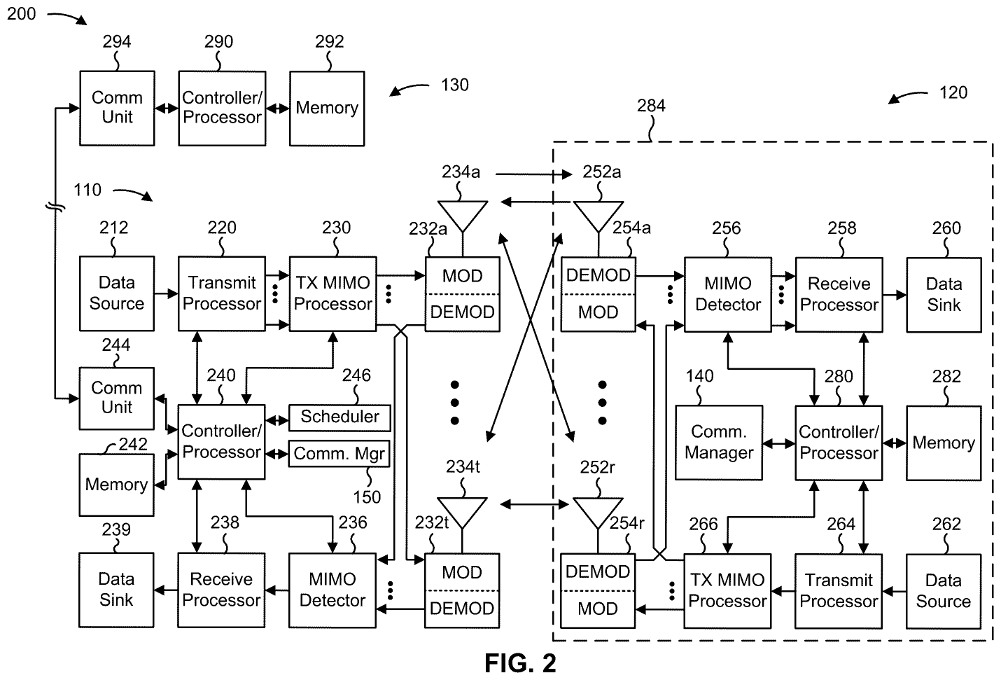

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more MCSs for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

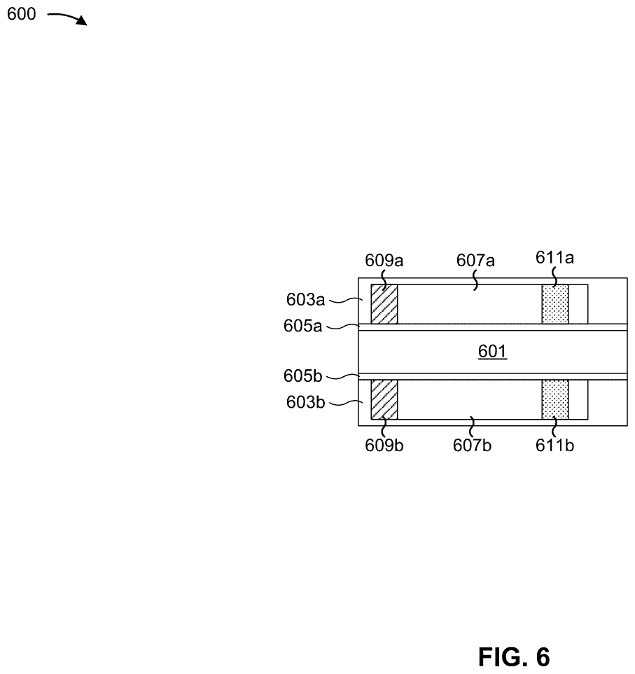

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-11).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-11).

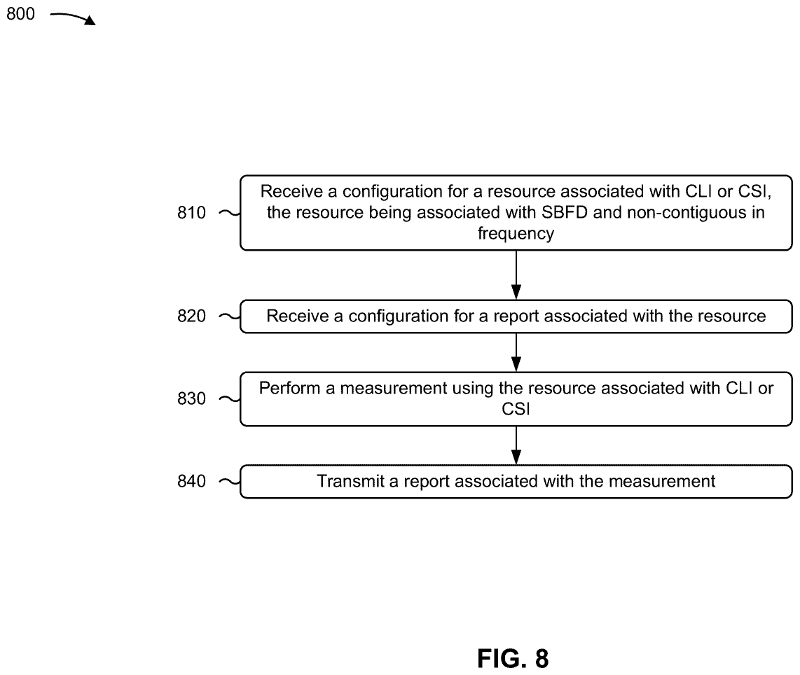

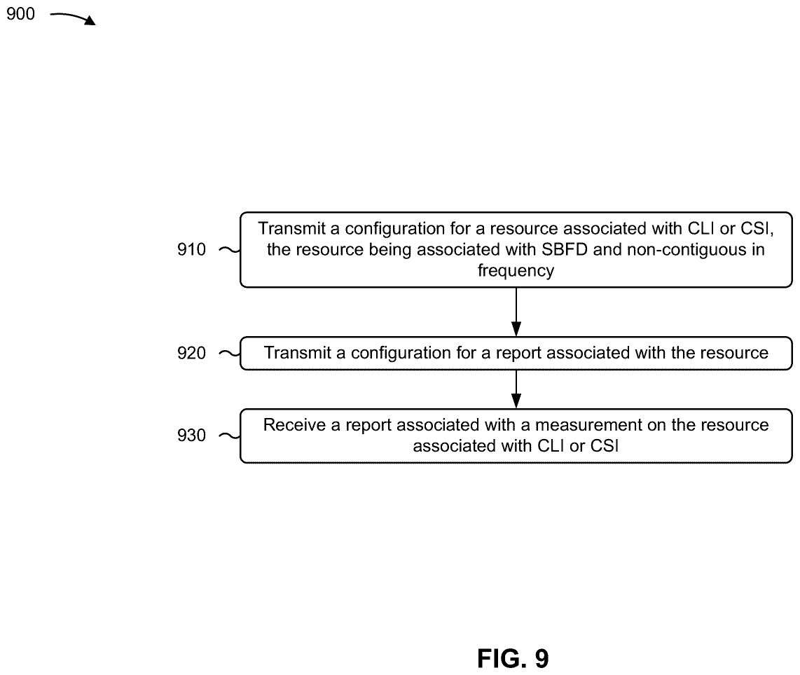

The controller/processor 240 of the network node 110, the controller/processor 280 of the UE 120, and/or any other component(s) of FIG. 2 may perform one or more techniques associated with configuring and using non-contiguous resources for CLI and CSI reports, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

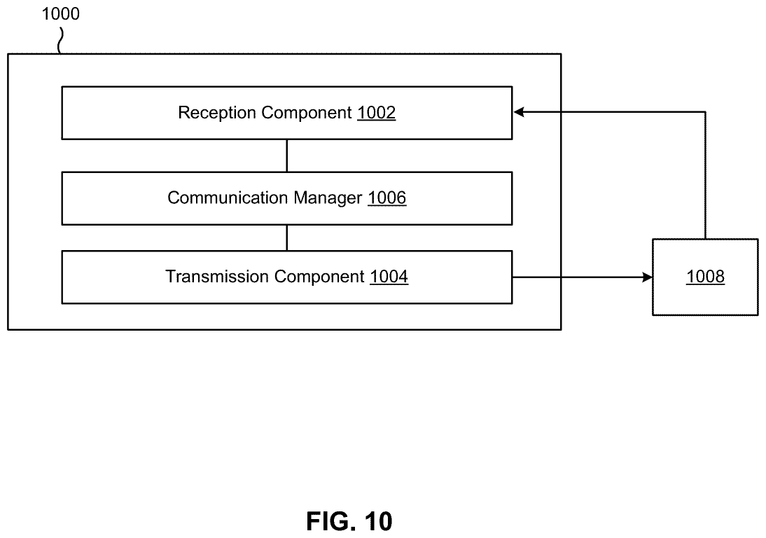

In some aspects, a UE (e.g., the UE 120 and/or apparatus 1000 of FIG. 10) may include means for receiving a configuration for a resource associated with CLI or CSI, wherein the resource is associated with SBFD and is non-contiguous in frequency; means for receiving a configuration for a report associated with the resource; means for performing a measurement using the resource associated with CLI or CSI; and/or means for transmitting a report associated with the measurement. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

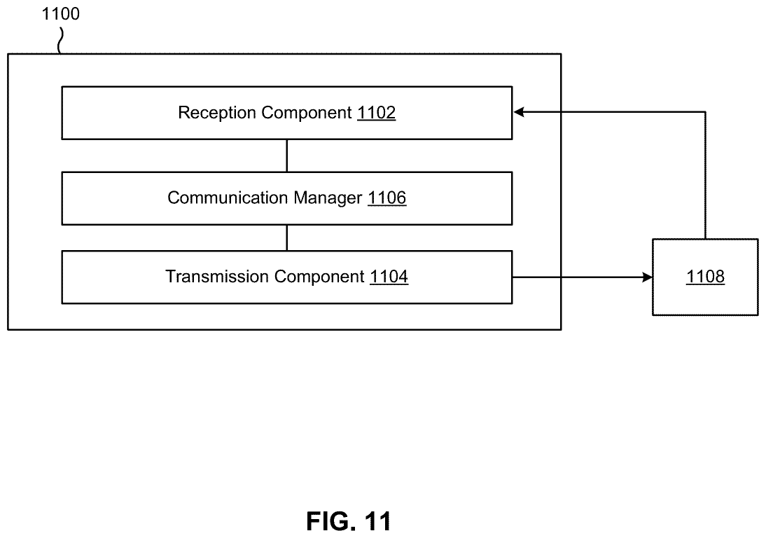

In some aspects, a network node (e.g., the network node 110, an RU 340, a DU 330, a CU 310, and/or apparatus 1100 of FIG. 11) may include means for transmitting a configuration for a resource associated with CLI or CSI, wherein the resource is associated with SBFD and is non-contiguous in frequency; means for transmitting a configuration for a report associated with the resource; and/or means for receiving a report associated with a measurement on the resource associated with CLI or CSI. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (CNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

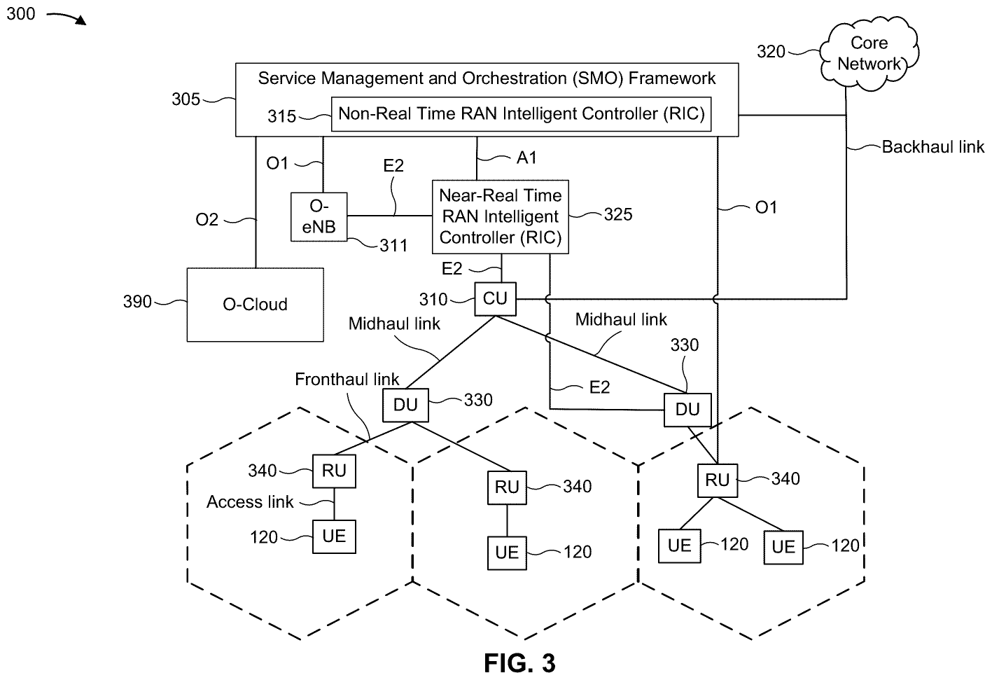

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-CNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an AI interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

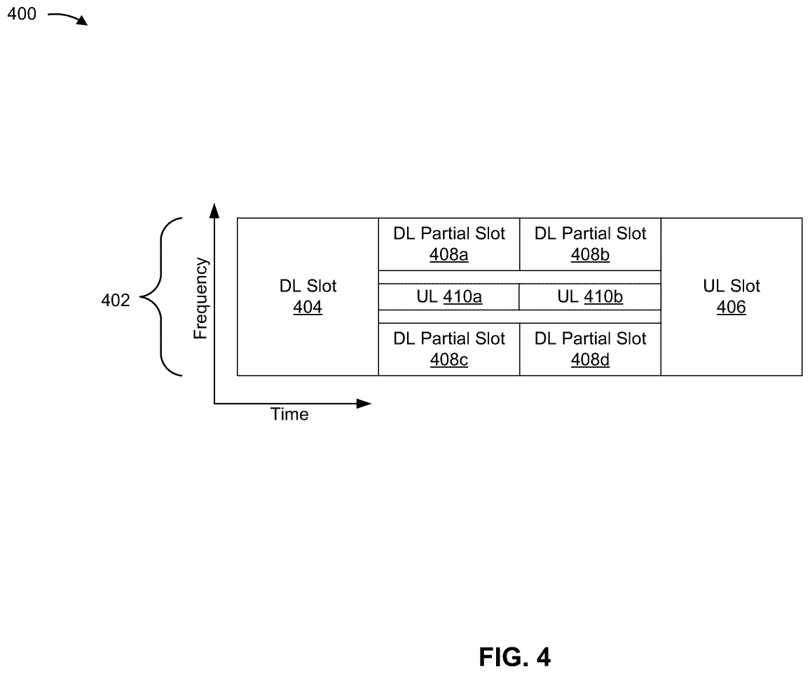

FIG. 4 is a diagram illustrating an example 400 of SBFD, in accordance with the present disclosure. As shown in FIG. 4, example 400 includes a configuration 402. In some aspects, first configuration 402 may indicate a slot format pattern (sometimes called a time division duplex (TDD) pattern) associated with a full-duplex mode. The slot format pattern may include a quantity of downlink slots (e.g., downlink slot 404, as shown), a quantity of flexible slots (not shown), and/or a quantity of uplink slots (e.g., uplink slot 406, as shown). The slot format pattern may repeat over time. In some aspects, a network node 110 may indicate the slot format pattern to a UE 120 using one or more slot format indicators (SFIs). An SFI, for a slot, may indicate whether that slot is an uplink slot, a downlink slot, or a flexible slot, among other examples.

In example 400, the slot format pattern further includes two SBFD slots. In example 400, each SBFD slot includes a partial slot (e.g., a portion or sub-band of a frequency allocated for use by the network node 110 and the UE 120) for downlink (e.g., partial slots 408a, 408b, 408c, and 408d, as shown) and a partial slot for uplink (e.g., partial slots 410a and 410b, as shown). Accordingly, the UE 120 may operate using the SBFD slots to transmit an uplink communication in an earlier slot (e.g., the second slot in sequence, shown as partial UL slot 410a) as compared to using the non-SBFD slots (e.g., the fourth slot in sequence, shown as UL slot 406). An “SBFD slot” may refer to a slot in which an SBFD format is used. An SBFD format may include a slot format in which full duplex communication is supported (e.g., for both uplink and downlink communications), with one or more frequencies used for an uplink portion of the slot being separated from one or more frequencies used for a downlink portion of the slot by a guard band. In some aspects, the SBFD format may include a single uplink portion and a single downlink portion separated by a guard band, as described in connection with FIG. 6. In some aspects, the SBFD format may include multiple downlink portions and a single uplink portion that is separated from the multiple downlink portions by respective guard bands (e.g., as shown in FIG. 4). In some aspects, an SBFD format may include multiple uplink portions and a single downlink portion that is separated from the multiple uplink portions by respective guard bands. In some aspects, the SBFD format may include multiple uplink portions and multiple downlink portions, where each uplink portion is separated from a downlink portion by a guard band. In some aspects, operating using an SBFD mode may include activating or using a full duplex (FD) mode in one or more slots based at least in part on the one or more slots having the SBFD format. A slot may support the SBFD mode if an UL bandwidth part (BWP) and a DL BWP are permitted to be or are simultaneously active in the slot in an SBFD fashion (e.g., with guard band separation).

Some techniques and apparatuses described herein enable the network node 110 to configure measurement resources in downlink portions of SBFD slots (e.g., across the partial slots 408a, 408b, 408c, and/or 408d). As a result, the UE 120 measures with increased accuracy because the UE 120 may measure using RBs for downlink (e.g., frequencies of the partial slots 408a, 408b, 408c, and/or 408d) and not using RBs for uplink (e.g., frequencies of the partial slots 410a and/or 410b).

As indicated above, FIG. 4 is provided as an example. Other examples may differ from what is described with respect to FIG. 4.

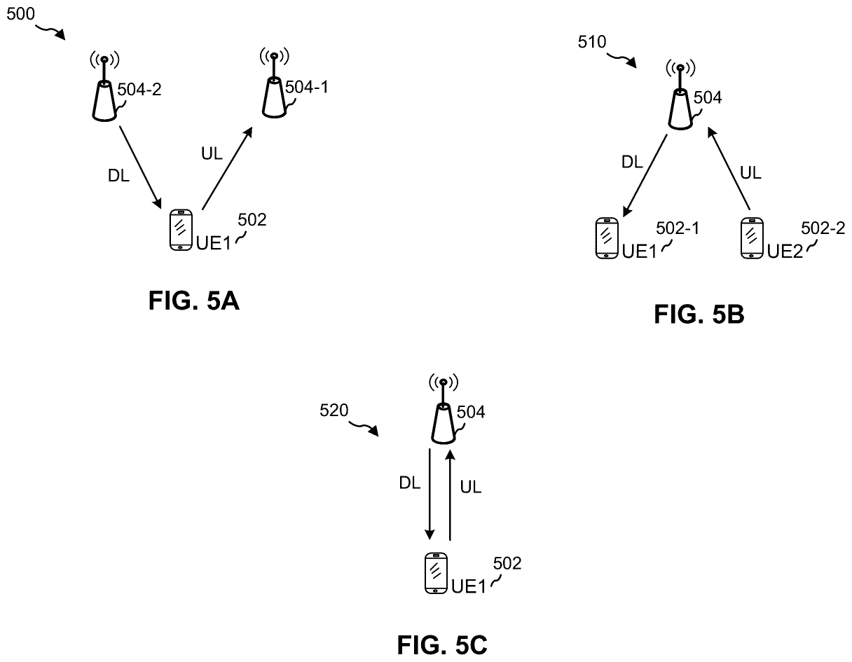

FIGS. 5A-5C are diagrams illustrating examples 500, 510, 520 of FD communication in accordance with the present disclosure. The example 500 of FIG. 5A includes a UE1 502 and two TRPs 504-1, 504-2, where the UE1 502 is sending UL transmissions to TRP 504-1 and is receiving DL transmissions from TRP 504-2. In the example 500 of FIG. 5A, FD is enabled for the UE1 502, but not for the TRPs 504-1, 504-2. The example 510 of FIG. 5B includes two UEs, shown as UE1 502-1 and UE2 502-2, and a TRP 504, where the UE1 502-1 is receiving a DL transmission from the TRP 504 and the UE2 502-2 is transmitting an UL transmission to the TRP 504. In the example 510 of FIG. 5B, FD is enabled for the TRP 504, but not for UE1 502-1 and UE2 502-2. The example 520 of FIG. 5C includes a UE1 502 and a TRP 504, where the UE1 502 is receiving a DL transmission from the TRP 504 and the UE1 502 is transmitting an UL transmission to the TRP 504. In the example 520 of FIG. 5C, FD is enabled for both the UE1 502 and the TRP 504.

During FD communications, both the network and UEs may experience CLI. For example, as shown in FIG. 5A, the TRP 504-1 may experience CLI from the DL transmission from the TRP 504-2. In another example, as shown in FIG. 5B, the UE1 502-1 may experience CLI from the UL transmission from the UE2 502-2. Some techniques and apparatuses described herein enable the TRP 504 to configure measurement resources associated with CLI in downlink portions of SBFD slots. As a result, the UE1 502-1 measures CLI with increased accuracy because the UE1 502-1 may measure within frequencies for downlink and not within frequencies for uplink.

As indicated above, FIGS. 5A-5C are provided as one or more examples. Other examples may differ from what is described with regard to FIGS. 5A-5C.

FIG. 6 is a diagram illustrating an example 600 associated with configuring and using non-contiguous resources for CLI and CSI reports, in accordance with the present disclosure. As shown in FIG. 6, example 600 includes an SBFD slot (or a portion thereof) for a UE 120. As used herein, “slot” may refer to a portion of a subframe, which in turn may be a fraction of a radio frame within an LTE, 5G, or another wireless communication structure. In some aspects, a slot may include one or more symbols. Additionally, “symbol” may refer to an OFDM symbol or another similar symbol within a slot.

As shown in FIG. 6, the SBFD slot may include an uplink subband 601. Although the example 600 is shown with a single uplink subband, other examples may include a plurality of uplink subbands. The SBFD slot further includes a first downlink subband 603a and a second downlink subband 603b. Although the example 600 is shown with two downlink subbands, other examples may include three or more downlink subbands. In some aspects, the first downlink subband 603a and the uplink subband 601 are separated by a first guard band 605a, and the second downlink subband 603b and the uplink subband 601 are separated by a second guard band 605b. Other examples may omit the guard bands 605a and 605b.

Each downlink subband may be configured with a downlink channel. For example, the first downlink subband 603a may be configured for a physical downlink shared channel (PDSCH) 607a that includes a corresponding DMRS 609a. Similarly, the second downlink subband 603b may be configured for a PDSCH 607b that includes a corresponding DMRS 609b. Therefore, the UE 120 may simultaneously transmit on the uplink subband 601 and receive on the first downlink subband 603a and/or the second downlink subband 603b.

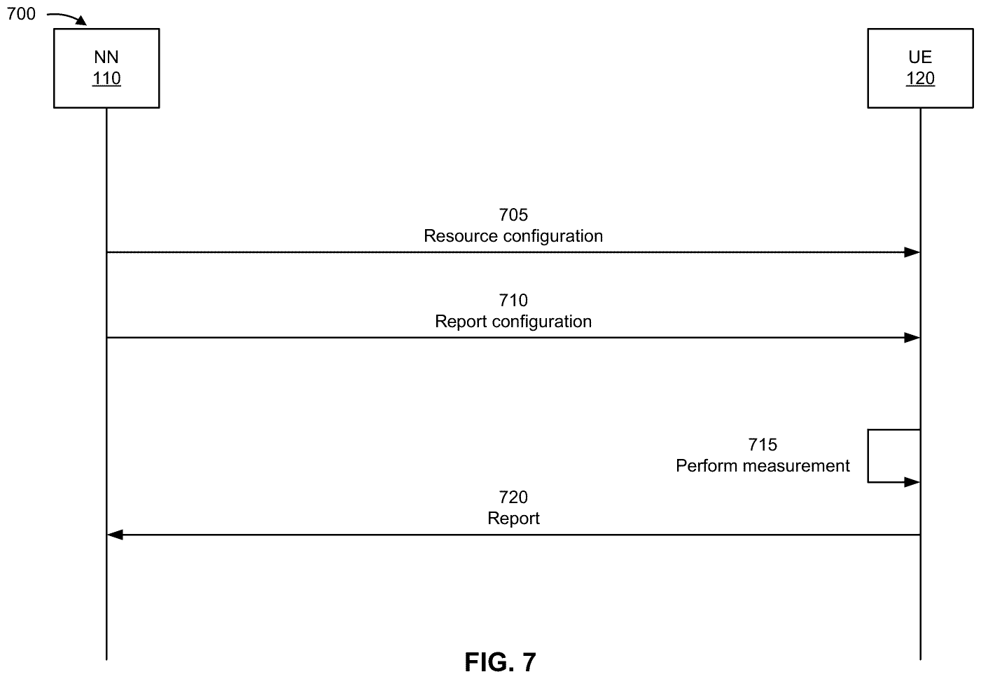

As further shown in FIG. 6, a network may configure a measurement resource 611, associated with SBFD, that is non-contiguous in frequency. For example, the measurement resource may include a first portion 611a of the first downlink subband 603a and a second portion 611b of the second downlink subband 603b. The measurement resource 611 may be associated with CLI or CSI. As described in connection with FIG. 7, the network may configure the first portion 611a and the second portion 611b using a data structure linking a configuration for the first portion 611a to a configuration for the second portion 611b or using a resource set including the first portion 611a and the second portion 611b. Alternatively, as described in connection with FIG. 7, the network may use a configuration for a CLI report or a CSI report to link a configuration for the first portion 611a to a configuration for the second portion 611b.

In order to configure the measurement resource 611 to exclude at least a portion of the uplink subband 601, the network may explicitly indicate the uplink subband 601 to exclude. For example, as described in connection with FIG. 7, the network may use a starting RB for exclusion and a quantity of RBs for exclusion or a bitmap indicating RBs for exclusion. In another example, as described in connection with FIG. 7, the network may use a starting RB for the first portion 611a, a quantity of RBs for the first portion 611a, a starting RB for the second portion 611b, and a quantity of RBs for the second portion 611b or may use a starting RB for the first portion 611a, an ending RB for the first portion 611a, a starting RB for the second portion 611b, and an ending RB for the second portion 611b. Alternatively, the UE may determine the uplink subband 601 to exclude, as described in connection with FIG. 7.

By using techniques as described in connection with FIG. 6, the network may configure the measurement resource 611 to exclude the uplink subband 601. As a result, the UE 120 measures with increased accuracy because the UE 120 may measure using RBs for downlink and not using RBs for uplink.

As indicated above, FIG. 6 is provided as an example. Other examples may differ from what is described with respect to FIG. 6.

FIG. 7 is a diagram illustrating an example 700 associated with configuring and using non-contiguous resources for CLI and CSI reports, in accordance with the present disclosure. As shown in FIG. 7, a network node 110 and a UE 120 may communicate with one another (e.g., using a wireless network, such as wireless network 100 of FIG. 1). The network node 110 may communicate directly (e.g., using an RU 340) or indirectly (e.g., by using a controller of the RU 340, such as a DU 330 and/or a CU 310).

As shown by reference number 705, the network node 110 may transmit, and the UE 120 may receive, a configuration for a resource associated with CLI or CSI. For example, the configuration may include an RSSI-ResourceConfigCLI information element (IE) or a CSI-ResourceConfig 1E, as described in 3GPP specifications and/or another standard. As described in connection with FIG. 6, the resource may be associated with SBFD and may be non-contiguous in frequency.

In some aspects, the network node 110 may transmit the configuration for the resource based at least in part on a quantity of occupied CSI processing units (CPUs) failing to satisfy a CPU threshold. The quantity of CPUs is derived from a quantity of measurement resources configured for the UE 120 (e.g., using formulae defined in 3GPP specifications and/or another standard). In some aspects, the network node 110 may always count the non-contiguous resource as a single resource (e.g., according to a rule to be added to 3GPP specifications and/or another standard). Therefore, the network node 110 may determine the quantity of occupied CSI processing units based at least in part on the resource counting as one resource. Alternatively, the network node 110 may always count the non-contiguous resource as two resources (e.g., according to a rule to be added to 3GPP specifications and/or another standard). Therefore, the network node 110 may determine the quantity of occupied CSI processing units based at least in part on the resource counting as two resources. In some aspects, the network node 110 may count the non-contiguous resource based at least in part on the configuration for the resource. For example, the network node 110 may count the non-contiguous resource as one resource based on the configuration for the resource including a single RRC data structure associated with both portions of the resource, and the network node 110 may count the non-contiguous resource as two resources based on the configuration for the resource including different RRC data structures associated with different portions of the resource.

In some aspects, the network node 110 may explicitly indicate one or more uplink RBs to be excluded from the resource. In one example, the configuration may indicate a starting RB for the resource and a quantity of RBs for the resource (e.g., indicated separately or indicated using a single resource indication value (RIV), as defined in 3GPP specifications) as well as a starting RB for exclusion and a quantity of RBs for exclusion (e.g., indicated separately or indicated using a single RIV). In another example, the configuration may indicate a starting RB for the resource and a quantity of RBs for the resource (e.g., indicated separately or indicated using a single RIV) and include a bitmap indicating the one or more uplink RBs to be excluded. The bitmap may be associated with a granularity of 4 RBs (e.g., each bit is associated with a set of RBs) to improve accuracy or with a larger granularity to reduce overhead. In another example, the configuration may indicate a starting RB for the resource and a quantity of RBs for the resource (e.g., indicated separately or indicated using a single RIV) and include a bit associated with exclusion of uplink resources. Accordingly, the UE 120 may determine the one or more uplink RBs to be excluded, in response to the bit, as an uplink subband associated with an SBFD configuration (e.g., as described in connection with FIG. 6).

In another example, the configuration may include a bitmap indicating the resource, along with the one or more uplink RBs to be excluded. For example, the one or more uplink RBs may be associated with zeroes in the bitmap. The bitmap may be associated with a granularity of 4 RBs (e.g., each bit is associated with a set of RBs) to improve accuracy or with a larger granularity to reduce overhead. In one example, the configuration may include a first bitmap indicating the resource and a second bitmap indicating RBs excluded from the resource. The first bitmap may be associated with a first granularity (e.g., larger than 4 RBs to reduce overhead) while the second bitmap may be associated with a second granularity (e.g., 4 RBs to improve accuracy).

In another example, the configuration may indicate a starting RB for a first portion of the resource and a quantity of RBs for the first portion of the resource (e.g., indicated separately or indicated using a single RIV) as well as a starting RB for a second portion of the resource and a quantity of RBs for the second portion of the resource (e.g., indicated separately or indicated using a single RIV). Accordingly, each downlink subband included in the resource is indicated using a separate starting RB and quantity of RBs (or a separate RIV encoding the starting RB and the quantity of RBs). In another example, the configuration may indicate a starting RB and a quantity of RBs for a first portion of the resource as well as a starting RB and a quantity of RBs for a second portion of the resource. Accordingly, each downlink subband included in the resource is indicated using separate starting and ending RBs.

In some aspects, the UE 120 may determine one or more uplink RBs to be excluded from the resource. In one example, the UE 120 may determine the one or more uplink RBs, to be excluded from the resource, as an uplink subband associated with an SBFD configuration (e.g., as described in connection with FIG. 6). Accordingly, the UE 120 keeps the one or more uplink RBs in the resource when measuring the resource in a non-SBFD slot (e.g., a legacy downlink slot, as shown in FIG. 6). In another example, the network node 110 may include a bit with the configuration to indicate whether the resource is a non-SBFD resource (e.g., by setting the bit to ‘0’ or FALSE) or an SBFD resource (e.g., by setting the bit to ‘1’ or TRUE). Accordingly, the UE 120 may determine the one or more uplink RBs to be excluded from the resource, in response to the bit, as an uplink subband associated with an SBFD configuration. The UE 120 keeps the one or more uplink RBs in the resource when measuring the resource in a non-SBFD slot (e.g., a legacy downlink slot, as shown in FIG. 6).

In some aspects, the network node 110 may indicate the resource using a plurality of configurations that are linked. In one example, the configuration for the resource includes a first configuration for a first portion of the resource, a second configuration for a second portion of the resource, and a data structure linking the first configuration to the second configuration. An IE may be added to 3GPP specifications (and/or another standard) that is defined as a set of resources, such that CLI-RSSI-resource-SBFD may be the configuration for the resource and may include a first IE CLI-RSSI-resource defining the first portion of the resource and a second IE CLI-RSSI-resource defining the second portion of the resource. Alternatively, each portion of the resource may be defined in an IE including a linking identifier (e.g., a CLI-LinkingID parameter to be added to 3GPP specifications and/or another standard) such that resource portions associated with a same linking identifier are linked together (e.g., the UE 120 determines to measure both portions together). Alternatively, the first portion of the resource may be defined in an IE including an identifier (e.g., a CLI-ResourceID parameter to be added to 3GPP specifications and/or another standard) associated with the second portion of the resource. Additionally, or alternatively, the second portion of the resource may be defined in an IE including an identifier (e.g., a CLI-ResourceID parameter to be added to 3GPP specifications and/or another standard) associated with the first portion of the resource. Therefore, a first portion of the resource may indicate a second portion of the resource with which the first portion is linked (e.g., the UE 120 uses the identifiers to determine to measure both portions together).

In another example, the configuration may define a resource set that includes a first portion of the resource and a second portion of the resource. For example, an IE may be added to 3GPP specifications (and/or another standard) that indicates the resource set with the first portion and the second portion. 3GPP specifications (and/or another standard) may indicate rules that apply to the resource set. For example, the network node 110 may ensure that all resources in the set are non-overlapping in frequency and/or are only included in downlink subbands associated with an SBFD configuration. Accordingly, the UE 120 will discard any resource set that does not satisfy the rules. Alternatively, 3GPP specifications (and/or another standard) may allow the network node 110 to configure resources in a set that are overlapping in frequency and/or are outside downlink subbands associated with an SBFD configuration.

As shown by reference number 710, the network node 110 may transmit, and the UE 120 may receive, a configuration for a report associated with the resource. For example, the configuration may be associated with a report of CLI measurements using the resource or with a CSI report of CSI-RS measurements using the resource. In some aspects, the configuration for the report may link a first configuration for the first portion of the resource and a second configuration for the second portion of the resource. For example, the configuration for the report may include an identifier associated with the first configuration and an identifier associated with the second configuration such that the UE 120 determines to measure both portions of the resource (and, optionally, combine raw measurements from both portions when calculating RSSI and/or another type of derived measurement) when generating the report. The configuration for the report may be an RRC message that links the configurations associated with the portions of the resource. Additionally, or alternatively, for semi-periodic reports, the network node 110 may transmit, and the UE 120 may receive, a MAC control element (MAC-CE) that links the configurations associated with the portions of the resource. For example, the MAC-CE may include an identifier associated with the first configuration and an identifier associated with the second configuration such that the UE 120 determines to measure both portions of the resource (and, optionally, combine raw measurements from both portions when calculating RSSI and/or another type of derived measurement) when generating the report. Additionally, or alternatively, for aperiodic and semi-periodic reports, the network node 110 may transmit, and the UE 120 may receive, downlink control information (DCI) that links the configurations associated with the portions of the resource. For example, the DCI may include an identifier associated with the first configuration and an identifier associated with the second configuration such that the UE 120 determines to measure both portions of the resource (and, optionally, combine raw measurements from both portions when calculating RSSI and/or another type of derived measurement) when generating the report.

As shown by reference number 715, the UE 120 may perform a measurement using the resource associated with CLI or CSI. In some aspects, the UE 120 may perform the measurement in a guard band, as described in connection with FIG. 6, in addition to downlink subbands (e.g., when the UE 120 determines the one or more uplink RBs to exclude using the uplink subband and/or when the network node 110 indicates to measure the guard band). Alternatively, the UE 120 may exclude one or more RBs in the guard band, as described in connection with FIG. 6, in addition to the one or more uplink RBs (e.g., when the UE 120 determines the one or more uplink RBs to exclude using the uplink subband and/or when the network node 110 indicates to refrain from measuring the guard band).

When the report is periodic or semi-periodic, the UE 120 may determine whether to perform the measurement in non-SBFD slots. For example, the UE 120 may perform the measurement on the resource (excluding the one or more uplink RBs) within a non-SBFD slot. Alternatively, the UE 120 may refrain from performing the measurement within non-SBFD slots.

In some aspects, the network node 110 may indicate one or more additional RBs, and the UE 120 may perform the measurement on the resource and on the one or more additional RBs within a non-SBFD slot. For example, the configuration for the resource may indicate the one or more additional RBs using a starting RB and a quantity of RBs (e.g., indicated separately or indicated using a single RIV) or using a starting RB and an ending RB. Alternatively, the configuration for the resource may include a bitmap that indicates the one or more additional RBs. In some aspects, the UE 120 may determine the one or more additional RBs, and the UE 120 may perform the measurement on the resource and on the one or more additional RBs within a non-SBFD slot. For example, the UE 120 may determine the one or more additional RBs based at least in part on a BW associated with the resource (e.g., including all RBs of the BW rather than only RBs indicated in the configuration for the resource). In another example, the configuration for the resource may include at least one bitmap, and the UE 120 may determine the one or more additional RBs based at least in part on the at least one bitmap (e.g., including all RBs indicated in the at least one bitmap rather than only RBs indicated as included and/or indicated as not excluded). Similarly, the UE 120 may determine to include all RBs indicated as included and/or indicated as not excluded in the at least one bitmap as well as any RBs therebetween (e.g., by closing gaps such that the resource and the one or more additional RBs form a contiguous set). In another example, the configuration for the resource may indicate starting RBs and quantities of RBs, as described above in connection with reference number 705, such that UE 120 may determine the one or more additional RBs based at least in part thereon (e.g., by selecting a minimum of the starting RBs and selecting a maximum ending RB based on the quantities of RBs). Similarly, the configuration for the resource may indicate starting RBs and ending RBs, as described above in connection with reference number 705, such that UE 120 may determine the one or more additional RBs based at least in part thereon (e.g., by selecting a minimum of the starting RBs and selecting a maximum of the ending RBs).

In some aspects, the UE 120 may perform the measurement based at least in part on the quantity of occupied CPUs failing to satisfy the CPU threshold. The quantity of CPUs is derived from a quantity of measurement resources configured for the UE 120 (e.g., using formulae defined in 3GPP specifications and/or another standard). In some aspects, the UE 120 may always count the non-contiguous resource as a single resource (e.g., according to a rule to be added to 3GPP specifications and/or another standard). Therefore, the UE 120 may determine the quantity of occupied CSI processing units based at least in part on the resource counting as one resource. Alternatively, the UE 120 may always count the non-contiguous resource as two resources (e.g., according to a rule to be added to 3GPP specifications and/or another standard). Therefore, the UE 120 may determine the quantity of occupied CSI processing units based at least in part on the resource counting as two resources. In some aspects, the UE 120 may count the non-contiguous resource based at least in part on the configuration for the resource. For example, the UE 120 may count the non-contiguous resource as one resource based on the configuration for the resource including a single RRC data structure associated with both portions of the resource, and the UE 120 may count the non-contiguous resource as two resources based on the configuration for the resource including different RRC data structures associated with different portions of the resource. Similarly, the UE 120 may refrain from performing the measurement based at least in part on a quantity of occupied CPUs satisfying the CPU threshold.

As shown by reference number 720, the UE 120 may transmit, and the network node 110 may receive, a report associated with the measurement. The report may include one or more raw measurements associated with the resource (e.g., one or more RSRPs) and/or one or more derived measurements associated with the resource (e.g., one or more RSSIs). Accordingly, the network node 110 may mitigate CLI and/or optimize channel parameters with the UE 120 using the report.

By using techniques as described in connection with FIG. 7, the network node 110 may configure the resource to exclude the one or more uplink RBs. As a result, the UE 120 performs the measurement with increased accuracy, and the measurement may be used to increase quality and reliability of communications between the network node 110 and the UE 120.

As indicated above, FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., UE 120 and/or apparatus 1000 of FIG. 10) performs operations associated with using non-contiguous resources for CLI and CSI reports.

As shown in FIG. 8, in some aspects, process 800 may include receiving a configuration for a resource associated with CLI or CSI, the resource being associated with SBFD and non-contiguous in frequency (block 810). For example, the UE (e.g., using reception component 1002 and/or communication manager 1006, depicted in FIG. 10) may receive a configuration for a resource associated with CLI or CSI, the resource being associated with SBFD and non-contiguous in frequency, as described herein.

As further shown in FIG. 8, in some aspects, process 800 may include receiving a configuration for a report associated with the resource (block 820). For example, the UE (e.g., using reception component 1002 and/or communication manager 1006) may receive a configuration for a report associated with the resource, as described herein.

As further shown in FIG. 8, in some aspects, process 800 may include performing a measurement using the resource associated with CLI or CSI (block 830). For example, the UE (e.g., using communication manager 1006) may perform a measurement using the resource associated with CLI or CSI, as described herein.

As further shown in FIG. 8, in some aspects, process 800 may include transmitting a report associated with the measurement (block 840). For example, the UE (e.g., using transmission component 1004 and/or communication manager 1006, depicted in FIG. 10) may transmit a report associated with the measurement, as described herein.

Process 800 may include additional aspects, such as any single aspect or any combination of aspects described below and/or in connection with one or more other processes described elsewhere herein.

In a first aspect, the configuration for the resource indicates a starting RB for the resource, a quantity of RBs for the resource, and one or more uplink RBs to be excluded from the resource.

In a second aspect, alone or in combination with the first aspect, the configuration for the resource indicates the one or more uplink RBs to be excluded with a starting RB for exclusion and a quantity of RBs for exclusion.

In a third aspect, alone or in combination with one or more of the first and second aspects, the configuration for the resource indicates the one or more uplink RBs to be excluded with a bitmap.

In a fourth aspect, alone or in combination with one or more of the first through third aspects, the configuration for the resource includes a bit associated with exclusion of uplink resources, and process 800 includes determining (e.g., using communication manager 1006) the one or more uplink RBs to be excluded, in response to the bit, as an uplink subband associated with an SBFD configuration.

In a fifth aspect, alone or in combination with one or more of the first through fourth aspects, the configuration for the resource indicates the resource with a bitmap.

In a sixth aspect, alone or in combination with one or more of the first through fifth aspects, the configuration for the resource indicates RBs included in the resource with a first bitmap associated with a first granularity and indicates RBs excluded from the resource with a second bitmap associated with a second granularity.

In a seventh aspect, alone or in combination with one or more of the first through sixth aspects, the configuration for the resource indicates a starting RB for a first portion of the resource, a quantity of RBs for the first portion of the resource, a starting RB for a second portion of the resource, and a quantity of RBs for the second portion of the resource.

In an eighth aspect, alone or in combination with one or more of the first through seventh aspects, the configuration for the resource indicates a starting RB for a first portion of the resource, an ending RB for the first portion of the resource, a starting RB for a second portion of the resource, and an ending RB for the second portion of the resource.

In a ninth aspect, alone or in combination with one or more of the first through eighth aspects, process 800 includes determining (e.g., using communication manager 1006) one or more uplink RBs, to be excluded from the resource, as an uplink subband associated with an SBFD configuration.

In a tenth aspect, alone or in combination with one or more of the first through ninth aspects, the configuration for the resource includes a bit associated with SBFD, and process 800 includes (e.g., using communication manager 1006) determining one or more uplink RBs to be excluded from the resource, in response to the bit, as an uplink subband associated with an SBFD configuration.

In an eleventh aspect, alone or in combination with one or more of the first through tenth aspects, performing the measurement includes performing the measurement, on the resource, within a non-SBFD slot.

In a twelfth aspect, alone or in combination with one or more of the first through eleventh aspects, performing the measurement includes performing the measurement, on the resource and on one or more additional RBs, within a non-SBFD slot.

In a thirteenth aspect, alone or in combination with one or more of the first through twelfth aspects, the configuration for the resource indicates a starting RB, with a quantity of RBs or with an ending RB, for the one or more additional RBs.

In a fourteenth aspect, alone or in combination with one or more of the first through thirteenth aspects, the configuration for the resource includes a bitmap indicating the one or more additional RBs.

In a fifteenth aspect, alone or in combination with one or more of the first through fourteenth aspects, process 800 includes determining (e.g., using communication manager 1006) the one or more additional RBs based at least in part on a bandwidth associated with the resource.

In a sixteenth aspect, alone or in combination with one or more of the first through fifteenth aspects, process 800 includes determining (e.g., using communication manager 1006) the one or more additional RBs based at least in part on a bitmap included in the configuration for the resource.

In a seventeenth aspect, alone or in combination with one or more of the first through sixteenth aspects, process 800 includes determining (e.g., using communication manager 1006) the one or more additional RBs based at least in part on a starting RB and a quantity of RBs indicated in the configuration for the resource.

In an eighteenth aspect, alone or in combination with one or more of the first through seventeenth aspects, process 800 includes determining (e.g., using communication manager 1006) the one or more additional RBs based at least in part on a starting RB and an ending RB indicated in the configuration for the resource.

In a nineteenth aspect, alone or in combination with one or more of the first through eighteenth aspects, process 800 includes refraining from performing (e.g., using communication manager 1006) the measurement within a non-SBFD slot.

In a twentieth aspect, alone or in combination with one or more of the first through nineteenth aspects, the configuration for the resource includes a first configuration for a first portion of the resource, a second configuration for a second portion of the resource, and a data structure linking the first configuration to the second configuration.

In a twenty-first aspect, alone or in combination with one or more of the first through twentieth aspects, the configuration for the resource indicates a resource set including a first portion of the resource and a second portion of the resource.

In a twenty-second aspect, alone or in combination with one or more of the first through twenty-first aspects, the configuration for the resource includes a first configuration for a first portion of the resource and a second configuration for a second portion of the resource, and the configuration for the report links the first configuration and the second configuration.

In a twenty-third aspect, alone or in combination with one or more of the first through twenty-second aspects, the configuration for the report includes an RRC message.

In a twenty-fourth aspect, alone or in combination with one or more of the first through twenty-third aspects, process 800 includes receiving (e.g., using reception component 1002 and/or communication manager 1006) a MAC-CE associated with the resource.

In a twenty-fifth aspect, alone or in combination with one or more of the first through twenty-fourth aspects, process 800 includes receiving (e.g., using reception component 1002 and/or communication manager 1006) DCI associated with the resource.

In a twenty-sixth aspect, alone or in combination with one or more of the first through twenty-fifth aspects, process 800 includes determining (e.g., using communication manager 1006) a quantity of occupied CPUs based at least in part on the resource counting as one resource.

In a twenty-seventh aspect, alone or in combination with one or more of the first through twenty-sixth aspects, process 800 includes determining (e.g., using communication manager 1006) a quantity of occupied CPUs based at least in part on the configuration for the resource.

In a twenty-eighth aspect, alone or in combination with one or more of the first through twenty-seventh aspects, process 800 includes determining (e.g., using communication manager 1006) a quantity of occupied CPUs based at least in part on the resource counting as two resources.

In a twenty-ninth aspect, alone or in combination with one or more of the first through twenty-eighth aspects, process 800 includes refraining from performing (e.g., using communication manager 1006) the measurement based at least in part on a quantity of occupied CPUs satisfying a CPU threshold.

In a thirtieth aspect, alone or in combination with one or more of the first through twenty-ninth aspects, the resource is associated with CLI measurement.

In a thirty-first aspect, alone or in combination with one or more of the first through thirtieth aspects, the resource is associated with CSI measurement.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network node, in accordance with the present disclosure. Example process 900 is an example where the network node (e.g., network node 110 and/or apparatus 1100 of FIG. 11) performs operations associated with configuring non-contiguous resources for CLI and CSI reports.

As shown in FIG. 9, in some aspects, process 900 may include transmitting a configuration for a resource associated with CLI or CSI, the resource being associated with SBFD and non-contiguous in frequency (block 910). For example, the network node (e.g., using transmission component 1104 and/or communication manager 1106, depicted in FIG. 11) may transmit a configuration for a resource associated with CLI or CSI, the resource being associated with SBFD and non-contiguous in frequency, as described herein.

As further shown in FIG. 9, in some aspects, process 900 may include transmitting a configuration for a report associated with the resource (block 920). For example, the network node (e.g., using transmission component 1104 and/or communication manager 1106) may transmit a configuration for a report associated with the resource, as described herein.

As further shown in FIG. 9, in some aspects, process 900 may include receiving a report associated with a measurement on the resource associated with CLI or CSI (block 930). For example, the network node (e.g., using reception component 1102 and/or communication manager 1106, depicted in FIG. 11) may receive a report associated with a measurement on the resource associated with CLI or CSI, as described herein.

Process 900 may include additional aspects, such as any single aspect or any combination of aspects described below and/or in connection with one or more other processes described elsewhere herein.

In a first aspect, the configuration for the resource indicates a starting RB for the resource, a quantity of RBs for the resource, and one or more uplink RBs to be excluded from the resource.

In a second aspect, alone or in combination with the first aspect, the configuration for the resource indicates the one or more uplink RBs to be excluded with a starting RB for exclusion and a quantity of RBs for exclusion.

In a third aspect, alone or in combination with one or more of the first and second aspects, the configuration for the resource indicates the one or more uplink RBs to be excluded with a bitmap.

In a fourth aspect, alone or in combination with one or more of the first through third aspects, the configuration for the resource includes a bit associated with exclusion of uplink resources.

In a fifth aspect, alone or in combination with one or more of the first through fourth aspects, the configuration for the resource indicates the resource with a bitmap.

In a sixth aspect, alone or in combination with one or more of the first through fifth aspects, the configuration for the resource indicates RBs included in the resource with a first bitmap associated with a first granularity and indicates RBs excluded from the resource with a second bitmap associated with a second granularity.

In a seventh aspect, alone or in combination with one or more of the first through sixth aspects, the configuration for the resource indicates a starting RB for a first portion of the resource, a quantity of RBs for the first portion of the resource, a starting RB for a second portion of the resource, and a quantity of RBs for the second portion of the resource.

In an eighth aspect, alone or in combination with one or more of the first through seventh aspects, the configuration for the resource indicates a starting RB for a first portion of the resource, an ending RB for the first portion of the resource, a starting RB for a second portion of the resource, and an ending RB for the second portion of the resource.

In a ninth aspect, alone or in combination with one or more of the first through eighth aspects, the configuration for the resource includes a bit associated with SBFD.

In a tenth aspect, alone or in combination with one or more of the first through ninth aspects, the measurement is further associated with one or more additional RBs within a non-SBFD slot.

In an eleventh aspect, alone or in combination with one or more of the first through tenth aspects, the configuration for the resource indicates a starting RB, with a quantity of RBs or with an ending RB, for the one or more additional RBs.

In a twelfth aspect, alone or in combination with one or more of the first through eleventh aspects, the configuration for the resource includes a bitmap indicating the one or more additional RBs.

In a thirteenth aspect, alone or in combination with one or more of the first through twelfth aspects, process 900 includes determining (e.g., using communication manager 1106) the one or more additional RBs based at least in part on a bandwidth associated with the resource.

In a fourteenth aspect, alone or in combination with one or more of the first through thirteenth aspects, process 900 includes determining (e.g., using communication manager 1106) the one or more additional RBs based at least in part on a bitmap included in the configuration for the resource.

In a fifteenth aspect, alone or in combination with one or more of the first through fourteenth aspects, process 900 includes determining the one or more additional RBs based at least in part on a starting RB and a quantity of RBs indicated in the configuration for the resource.

In a sixteenth aspect, alone or in combination with one or more of the first through fifteenth aspects, process 900 includes determining (e.g., using communication manager 1106) the one or more additional RBs based at least in part on a starting RB and an ending RB indicated in the configuration for the resource.

In a seventeenth aspect, alone or in combination with one or more of the first through sixteenth aspects, the configuration for the resource includes a first configuration for a first portion of the resource, a second configuration for a second portion of the resource, and an information element linking the first configuration to the second configuration.

In an eighteenth aspect, alone or in combination with one or more of the first through seventeenth aspects, the configuration for the resource indicates a resource set including a first portion of the resource and a second portion of the resource.

In a nineteenth aspect, alone or in combination with one or more of the first through eighteenth aspects, the configuration for the resource includes a first configuration for a first portion of the resource and a second configuration for a second portion of the resource, and the configuration for the report links the first configuration and the second configuration.

In a twentieth aspect, alone or in combination with one or more of the first through nineteenth aspects, the configuration for the report includes an RRC message.

In a twenty-first aspect, alone or in combination with one or more of the first through twentieth aspects, process 900 includes transmitting (e.g., using transmission component 1104 and/or communication manager 1106) a MAC-CE associated with the resource.

In a twenty-second aspect, alone or in combination with one or more of the first through twenty-first aspects, process 900 includes transmitting (e.g., using transmission component 1104 and/or communication manager 1106) DCI associated with the resource.

In a twenty-third aspect, alone or in combination with one or more of the first through twenty-second aspects, process 900 includes determining (e.g., using communication manager 1106) a quantity of occupied CPUs based at least in part on the resource counting as one resource.

In a twenty-fourth aspect, alone or in combination with one or more of the first through twenty-third aspects, process 900 includes determining (e.g., using communication manager 1106) a quantity of occupied CPUs based at least in part on the configuration for the resource.

In a twenty-fifth aspect, alone or in combination with one or more of the first through twenty-fourth aspects, process 900 includes determining (e.g., using communication manager 1106) a quantity of occupied CPUs based at least in part on the resource counting as two resources.

In a twenty-sixth aspect, alone or in combination with one or more of the first through twenty-fifth aspects, process 900 includes transmitting (e.g., using transmission component 1104 and/or communication manager 1106) the configuration for the resource based at least in part on a quantity of occupied CPUs failing to satisfy a CPU threshold.

In a twenty-seventh aspect, alone or in combination with one or more of the first through twenty-sixth aspects, the resource is associated with CLI measurement.

In a twenty-eighth aspect, alone or in combination with one or more of the first through twenty-seventh aspects, the resource is associated with CSI measurement.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 140 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 6-7. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

In some aspects, the reception component 1002 may receive a configuration for a resource, associated with CLI or CSI, that is associated with SBFD and non-contiguous in frequency. The reception component 1002 may further receive a configuration for a report associated with the resource. Accordingly, the communication manager 1006 may perform a measurement using the resource associated with CLI or CSI, and the transmission component 1004 may transmit a report associated with the measurement. In some aspects, the communication manager 1006 may determine one or more uplink RBs, to be excluded from the resource, as an uplink subband associated with an SBFD configuration.

In some aspects, the communication manager 1006 may refrain from performing the measurement within a non-SBFD slot. Alternatively, the communication manager 1006 may perform the measurement in a non-SBFD slot using the resource and one or more additional RBs. The communication manager 1006 may determine the one or more additional RBs based at least in part on a bandwidth associated with the resource. Alternatively, the communication manager 1006 may determine the one or more additional RBs based at least in part on a bitmap included in the configuration for the resource. Alternatively, the communication manager 1006 may determine the one or more additional RBs based at least in part on a starting RB and a quantity of RBs indicated in the configuration for the resource. Additionally, or alternatively, the communication manager 1006 may determine the one or more additional RBs based at least in part on a starting RB and an ending RB indicated in the configuration for the resource.

The communication manager 1006 may refrain from performing the measurement based at least in part on a quantity of occupied CPUs satisfying a CPU threshold. In some aspects, the communication manager 1006 may determine a quantity of occupied CPUs based at least in part on the resource counting as one resource. Alternatively, the communication manager 1006 may determine a quantity of occupied CPUs based at least in part on the configuration for the resource. Alternatively, the communication manager 1006 may determine a quantity of occupied CPUs based at least in part on the resource counting as two resources.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 6-7. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network node described in connection with FIG. 2. In some aspects, the reception component 1102 and/or the transmission component 1104 may include or may be included in a network interface. The network interface may be configured to obtain and/or output signals for the apparatus 1100 via one or more communications links, such as a backhaul link, a midhaul link, and/or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, a modem, a modulator, a transmit MIMO processor, a transmit processor, a controller/processor, a memory, or a combination thereof, of the network node described in connection with FIG. 2. In some aspects, the transmission component 1104 may be co-located with the reception component 1102 in a transceiver.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

In some aspects, the transmission component 1104 may transmit a configuration for a resource, associated with CLI or CSI, that is associated with SBFD and non-contiguous in frequency. The transmission component 1104 may further transmit a configuration for a report associated with the resource. Accordingly, the reception component 1102 may receive a report associated with a measurement on the resource associated with CLI or CSI.

In some aspects, the report may be further associated with one or more additional RBs in a non-SBFD slot. The communication manager 1106 may determine the one or more additional RBs based at least in part on a bandwidth associated with the resource. Alternatively, the communication manager 1106 may determine the one or more additional RBs based at least in part on a bitmap included in the configuration for the resource. Alternatively, the communication manager 1106 may determine the one or more additional RBs based at least in part on a starting RB and a quantity of RBs indicated in the configuration for the resource. Alternatively, the communication manager 1106 may determine the one or more additional RBs based at least in part on a starting RB and an ending RB indicated in the configuration for the resource.

In some aspects, the transmission component 1104 may transmit the configuration for the resource based at least in part on a quantity of occupied CPUs failing to satisfy a CPU threshold. The communication manager 1106 may determine a quantity of occupied CPUs based at least in part on the resource counting as one resource. Alternatively, the communication manager 1106 may determine a quantity of occupied CPUs based at least in part on the configuration for the resource. Alternatively, the communication manager 1106 may determine a quantity of occupied CPUs based at least in part on the resource counting as two resources.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:
Aspect 1: A method of wireless communication performed by a user equipment (UE), comprising: receiving a configuration for a resource associated with cross-link interference (CLI) or channel state information (CSI), wherein the resource is associated with subband full duplex (SBFD) and is non-contiguous in frequency; receiving a configuration for a report associated with the resource; performing a measurement using the resource associated with CLI or CSI; and transmitting a report associated with the measurement.
Aspect 2: The method of Aspect 1, wherein the configuration for the resource indicates a starting resource block (RB) for the resource, a quantity of RBs for the resource, and one or more uplink RBs to be excluded from the resource.
Aspect 3: The method of Aspect 2, wherein the configuration for the resource indicates the one or more uplink RBs to be excluded with a starting RB for exclusion and a quantity of RBs for exclusion.
Aspect 4: The method of Aspect 2, wherein the configuration for the resource indicates the one or more uplink RBs to be excluded with a bitmap.
Aspect 5: The method of Aspect 2, wherein the configuration for the resource includes a bit associated with exclusion of uplink resources, and the method further comprises: determining the one or more uplink RBs to be excluded, in response to the bit, as an uplink subband associated with an SBFD configuration.
Aspect 6: The method of Aspect 1, wherein the configuration for the resource indicates the resource with a bitmap.
Aspect 7: The method of Aspect 1, wherein the configuration for the resource indicates resource blocks (RBs) included in the resource with a first bitmap associated with a first granularity and indicates RBs excluded from the resource with a second bitmap associated with a second granularity.
Aspect 8: The method of Aspect 1, wherein the configuration for the resource indicates a starting resource block (RB) for a first portion of the resource, a quantity of RBs for the first portion of the resource, a starting RB for a second portion of the resource, and a quantity of RBs for the second portion of the resource.
Aspect 9: The method of Aspect 1, wherein the configuration for the resource indicates a starting resource block (RB) for a first portion of the resource, an ending RB for the first portion of the resource, a starting RB for a second portion of the resource, and an ending RB for the second portion of the resource.
Aspect 10: The method of Aspect 1, further comprising: determining one or more uplink resource blocks, to be excluded from the resource, as an uplink subband associated with an SBFD configuration.
Aspect 11: The method of Aspect 1, wherein the configuration for the resource includes a bit associated with SBFD, and the method further comprises: determining one or more uplink resource blocks to be excluded from the resource, in response to the bit, as an uplink subband associated with an SBFD configuration.
Aspect 12: The method of any of Aspects 1-11, wherein performing the measurement comprises: performing the measurement, on the resource, within a non-SBFD slot.
Aspect 13: The method of any of Aspects 1-11, wherein performing the measurement comprises: performing the measurement, on the resource and on one or more additional resource blocks (RBs), within a non-SBFD slot.
Aspect 14: The method of Aspect 13, wherein the configuration for the resource indicates a starting RB, with a quantity of RBs or with an ending RB, for the one or more additional RBs.
Aspect 15: The method of Aspect 13, wherein the configuration for the resource includes a bitmap indicating the one or more additional RBs.
Aspect 16: The method of Aspect 13, further comprising: determining the one or more additional RBs based at least in part on a bandwidth associated with the resource.
Aspect 17: The method of Aspect 13, further comprising: determining the one or more additional RBs based at least in part on a bitmap included in the configuration for the resource.
Aspect 18: The method of Aspect 13, further comprising: determining the one or more additional RBs based at least in part on a starting RB and a quantity of RBs indicated in the configuration for the resource.
Aspect 19: The method of Aspect 13, further comprising: determining the one or more additional RBs based at least in part on a starting RB and an ending RB indicated in the configuration for the resource.
Aspect 20: The method of any of Aspects 1-11, further comprising: refraining from performing the measurement within a non-SBFD slot.
Aspect 21: The method of any of Aspects 1-20, wherein the configuration for the resource includes a first configuration for a first portion of the resource, a second configuration for a second portion of the resource, and a data structure linking the first configuration to the second configuration.
Aspect 22: The method of any of Aspects 1-20, wherein the configuration for the resource indicates a resource set including a first portion of the resource and a second portion of the resource.
Aspect 23: The method of any of Aspects 1-20, wherein the configuration for the resource includes a first configuration for a first portion of the resource and a second configuration for a second portion of the resource, and the configuration for the report links the first configuration and the second configuration.
Aspect 24: The method of any of Aspects 1-23, wherein the configuration for the report includes a radio resource control message.
Aspect 25: The method of any of Aspects 1-24, further comprising: receiving a medium access control (MAC) control element associated with the resource.
Aspect 26: The method of any of Aspects 1-25, further comprising: receiving downlink control information associated with the resource.
Aspect 27: The method of any of Aspects 1-26, further comprising: determining a quantity of occupied CSI processing units based at least in part on the resource counting as one resource.
Aspect 28: The method of any of Aspects 1-26, further comprising: determining a quantity of occupied CSI processing units based at least in part on the configuration for the resource.
Aspect 29: The method of any of Aspects 1-26, further comprising: determining a quantity of occupied CSI processing units based at least in part on the resource counting as two resources.
Aspect 30: The method of any of Aspects 1-29, further comprising: refraining from performing the measurement based at least in part on a quantity of occupied CSI processing units (CPUs) satisfying a CPU threshold.
Aspect 31: The method of any of Aspects 1-30, wherein the resource is associated with CLI measurement.
Aspect 32: The method of any of Aspects 1-30, wherein the resource is associated with CSI measurement.
Aspect 33: A method of wireless communication performed by a network node, comprising: transmitting a configuration for a resource associated with cross-link interference (CLI) or channel state information (CSI), wherein the resource is associated with subband full duplex (SBFD) and is non-contiguous in frequency; transmitting a configuration for a report associated with the resource; and receiving a report associated with a measurement on the resource associated with CLI or CSI.
Aspect 34: The method of Aspect 33, where the configuration for the resource indicates a starting resource block (RB) for the resource, a quantity of RBs for the resource, and one or more uplink RBs to be excluded from the resource.
Aspect 35: The method of Aspect 34, wherein the configuration for the resource indicates the one or more uplink RBs to be excluded with a starting RB for exclusion and a quantity of RBs for exclusion.
Aspect 36: The method of Aspect 34, wherein the configuration for the resource indicates the one or more uplink RBs to be excluded with a bitmap.
Aspect 37: The method of Aspect 34, wherein the configuration for the resource includes a bit associated with exclusion of uplink resources.
Aspect 38: The method of Aspect 33, wherein the configuration for the resource indicates the resource with a bitmap.
Aspect 39: The method of Aspect 33, wherein the configuration for the resource indicates resource blocks (RBs) included in the resource with a first bitmap associated with a first granularity and indicates RBs excluded from the resource with a second bitmap associated with a second granularity.
Aspect 40: The method of Aspect 33, wherein the configuration for the resource indicates a starting resource block (RB) for a first portion of the resource, a quantity of RBs for the first portion of the resource, a starting RB for a second portion of the resource, and a quantity of RBs for the second portion of the resource.
Aspect 41: The method of Aspect 33, wherein the configuration for the resource indicates a starting resource block (RB) for a first portion of the resource, an ending RB for the first portion of the resource, a starting RB for a second portion of the resource, and an ending RB for the second portion of the resource.
Aspect 42: The method of Aspect 33, wherein the configuration for the resource includes a bit associated with SBFD.
Aspect 43: The method of any of Aspects 33-42, wherein the measurement is further associated with one or more additional resource blocks (RBs) within a non-SBFD slot.
Aspect 44: The method of Aspect 43, wherein the configuration for the resource indicates a starting RB, with a quantity of RBs or with an ending RB, for the one or more additional RBs.
Aspect 45: The method of Aspect 43, wherein the configuration for the resource includes a bitmap indicating the one or more additional RBs.
Aspect 46: The method of Aspect 43, further comprising: determining the one or more additional RBs based at least in part on a bandwidth associated with the resource.
Aspect 47: The method of Aspect 43, further comprising: determining the one or more additional RBs based at least in part on a bitmap included in the configuration for the resource.
Aspect 48: The method of Aspect 43, further comprising: determining the one or more additional RBs based at least in part on a starting RB and a quantity of RBs indicated in the configuration for the resource.
Aspect 49: The method of Aspect 43, further comprising: determining the one or more additional RBs based at least in part on a starting RB and an ending RB indicated in the configuration for the resource.
Aspect 50: The method of any of Aspects 33-49, wherein the configuration for the resource includes a first configuration for a first portion of the resource, a second configuration for a second portion of the resource, and an information element linking the first configuration to the second configuration.
Aspect 51: The method of any of Aspects 33-49, wherein the configuration for the resource indicates a resource set including a first portion of the resource and a second portion of the resource.
Aspect 52: The method of any of Aspects 33-49, wherein the configuration for the resource includes a first configuration for a first portion of the resource and a second configuration for a second portion of the resource, and the configuration for the report links the first configuration and the second configuration.
Aspect 53: The method of any of Aspects 33-52, wherein the configuration for the report includes a radio resource control message.
Aspect 54: The method of any of Aspects 33-53, further comprising: transmitting a medium access control (MAC) control element associated with the resource.
Aspect 55: The method of any of Aspects 33-54, further comprising: transmitting downlink control information associated with the resource.
Aspect 56: The method of any of Aspects 33-55, further comprising: determining a quantity of occupied CSI processing units based at least in part on the resource counting as one resource.
Aspect 57: The method of any of Aspects 33-55, further comprising: determining a quantity of occupied CSI processing units based at least in part on the configuration for the resource.
Aspect 58: The method of any of Aspects 33-55, further comprising: determining a quantity of occupied CSI processing units based at least in part on the resource counting as two resources.
Aspect 59: The method of any of Aspects 33-58, further comprising: transmitting the configuration for the resource based at least in part on a quantity of occupied CSI processing units (CPUs) failing to satisfy a CPU threshold.
Aspect 60: The method of any of Aspects 33-59, wherein the resource is associated with CLI measurement.
Aspect 61: The method of any of Aspects 33-59, wherein the resource is associated with CSI measurement.
Aspect 62: An apparatus for wireless communication at a device, comprising a processor; memory coupled with the processor; and instructions stored in the memory and executable by the processor to cause the apparatus to perform the method of one or more of Aspects 1-61.
Aspect 63: A device for wireless communication, comprising one or more memories and one or more processors coupled to the one or more memories, the one or more processors configured to perform the method of one or more of Aspects 1-61.
Aspect 64: An apparatus for wireless communication, comprising at least one means for performing the method of one or more of Aspects 1-61.
Aspect 65: A non-transitory computer-readable medium storing code for wireless communication, the code comprising instructions executable by a processor to perform the method of one or more of Aspects 1-61.
Aspect 66: A non-transitory computer-readable medium storing a set of instructions for wireless communication, the set of instructions comprising one or more instructions that, when executed by one or more processors of a device, cause the device to perform the method of one or more of Aspects 1-61.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
one or more memories; and
one or more processors, coupled to the one or more memories, configured to:
receive a configuration for a resource associated with cross-link interference (CLI), wherein the resource is associated with subband full duplex (SBFD) and is non-contiguous in frequency;
receive a configuration for a report associated with the resource;
perform a measurement using the resource associated with CLI; and
transmit a report associated with the measurement.

2. The apparatus of claim 1, wherein the configuration for the resource indicates a starting resource block (RB) for the resource, a quantity of RBs for the resource, and one or more uplink RBs to be excluded from the resource.

3. The apparatus of claim 2, wherein the configuration for the resource indicates the one or more uplink RBs to be excluded with a starting RB for exclusion and a quantity of RBs for exclusion.

4. The apparatus of claim 2, wherein the configuration for the resource indicates the one or more uplink RBs to be excluded with a bitmap.

5. The apparatus of claim 2, wherein the configuration for the resource includes a bit associated with exclusion of uplink resources, and the one or more processors are configured to:
determine the one or more uplink RBs to be excluded, in response to the bit, as an uplink subband associated with an SBFD configuration.

6. The apparatus of claim 1, wherein the configuration for the resource indicates the resource with a bitmap.

7. The apparatus of claim 1, wherein the configuration for the resource indicates resource blocks (RBs) included in the resource with a first bitmap associated with a first granularity and indicates RBs excluded from the resource with a second bitmap associated with a second granularity.

8. The apparatus of claim 1, wherein the configuration for the resource indicates a starting resource block (RB) for a first portion of the resource, a quantity of RBs for the first portion of the resource, a starting RB for a second portion of the resource, and a quantity of RBs for the second portion of the resource.

9. The apparatus of claim 1, wherein the configuration for the resource indicates a starting resource block (RB) for a first portion of the resource, an ending RB for the first portion of the resource, a starting RB for a second portion of the resource, and an ending RB for the second portion of the resource.

10. The apparatus of claim 1, wherein the one or more processors are configured to:
determine one or more uplink resource blocks, to be excluded from the resource, as an uplink subband associated with an SBFD configuration.

11. The apparatus of claim 1, wherein the configuration for the resource includes a bit associated with SBFD, and the one or more processors are configured to:
determine one or more uplink resource blocks to be excluded from the resource, in response to the bit, as an uplink subband associated with an SBFD configuration.

12. The apparatus of claim 1, wherein, to perform the measurement, the one or more processors are configured to:
perform the measurement, on the resource, within a non-SBFD slot.

13. The apparatus of claim 1, wherein, to perform the measurement, the one or more processors are configured to:
perform the measurement, on the resource and on one or more additional resource blocks (RBs), within a non-SBFD slot.

14. The apparatus of claim 13, wherein the configuration for the resource indicates a starting RB, with a quantity of RBs or with an ending RB, for the one or more additional RBs.

15. The apparatus of claim 13, wherein the configuration for the resource includes a bitmap indicating the one or more additional RBs.

16. The apparatus of claim 13, wherein the one or more processors are configured to:
determine the one or more additional RBs based at least in part on a bandwidth associated with the resource.

17. The apparatus of claim 13, wherein the one or more processors are configured to:
determine the one or more additional RBs based at least in part on a bitmap included in the configuration for the resource.

18. The apparatus of claim 13, wherein the one or more processors are configured to:
determine the one or more additional RBs based at least in part on a starting RB and a quantity of RBs indicated in the configuration for the resource.

19. The apparatus of claim 13, wherein the one or more processors are configured to:
determine the one or more additional RBs based at least in part on a starting RB and an ending RB indicated in the configuration for the resource.

20. The apparatus of claim 1, wherein the one or more processors are configured to:
refrain from performing the measurement within a non-SBFD slot.

21. The apparatus of claim 1, wherein the configuration for the resource includes a first configuration for a first portion of the resource, a second configuration for a second portion of the resource, and a data structure linking the first configuration to the second configuration.

22. The apparatus of claim 1, wherein the configuration for the resource indicates a resource set including a first portion of the resource and a second portion of the resource.

23. The apparatus of claim 1, wherein the configuration for the resource includes a first configuration for a first portion of the resource and a second configuration for a second portion of the resource, and the configuration for the report links the first configuration and the second configuration.

24. The apparatus of claim 1, wherein the configuration for the report includes a radio resource control message.

25. The apparatus of claim 1, wherein the one or more processors are configured to:
receive a medium access control (MAC) control element associated with the resource.

26. The apparatus of claim 1, wherein the one or more processors are configured to:
receive downlink control information associated with the resource.

27. A non-transitory computer-readable medium storing a set of instructions for wireless communication, the set of instructions comprising:
one or more instructions that, when executed by one or more processors of a user equipment (UE), cause the UE to:
receive a configuration for a resource associated with cross-link interference (CLI), wherein the resource is associated with subband full duplex (SBFD) and is non-contiguous in frequency;
receive a configuration for a report associated with the resource;
perform a measurement using the resource associated with CLI; and
transmit a report associated with the measurement.

28. A method of wireless communication performed by a user equipment (UE), comprising:
receiving a configuration for a resource associated with cross-link interference (CLI), wherein the resource is associated with subband full duplex (SBFD) and is non-contiguous in frequency;
receiving a configuration for a report associated with the resource;
performing a measurement using the resource associated with CLI; and
transmitting a report associated with the measurement.

29. An apparatus for wireless communication at a network node, comprising:
one or more memories; and
one or more processors, coupled to the one or more memories, configured to:
transmit a configuration for a resource associated with cross-link interference (CLI), wherein the resource is associated with subband full duplex (SBFD) and is non-contiguous in frequency;
transmit a configuration for a report associated with the resource; and
receive a report associated with a measurement on the resource associated with CLI.

30. The apparatus of claim 29, wherein the configuration for the resource includes a first configuration for a first portion of the resource, a second configuration for a second portion of the resource, and a data structure linking the first configuration to the second configuration.
